(19) United States
(12) Patent Application Publication
(10) Pub. No.: US 2006/0217982 A1
(43) Pub. Date: Sep. 28, 2006

(54) Semiconductor chip having a text-to-speech system and a communication enabled device

(75) Inventor: Richard Munro, Livingston (GB)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 10/558,670

(22) PCT Filed: Mar. 10, 2005
(86) PCT No.: PCT/GB05/00920

§ 371 Date: Nov. 30, 2005

(30) Foreign Application Priority Data
Mar. 11, 2004 (GB) 0405497.9

(51) Int. Cl. G10L 13/08

(52) U.S. Cl. 704/260

(57) ABSTRACT

The present invention relates to a semiconductor chip having a Text-To-Speech (TTS) system and an applying means for use in a communication enabled device. The TTS system converts input text messages into output audio messages, the output audio message having characteristics set by a voice parameter set. The semiconductor chip also includes at least a first memory in which the voice parameter sets are stored. Any one of the voice parameter sets can be selected as the active voice parameter set for use when a text message is received.

The present invention relates to a semiconductor chip having a Text-To-Speech (TTS) system, and a communication enabled device comprising the semiconductor chip. In particular, the present invention relates to a semiconductor chip having a TTS system in which more than one voice parameter set may be used by the TTS system. More preferably, the present invention relates to the selection by a user of a voice parameter set to be the active voice parameter set output by the TTS system.

It is known from the prior art that communication enabled devices and in particular mobile telephones may be personalised, by a user, by assigning a ring tone to that mobile telephone. A plurality of pre-set ring tones may be stored in a mobile telephone prior to retail of the mobile telephone. Alternatively, a user may obtain ring tones from a ring tone provider via wireline or wireless communication. A user can download a ring tone from a web page via the internet, or a ring tone may be sent to a user's mobile telephone attached to a Short Message Service (SMS) text message. A user can select any one of the pre-set or downloaded ring tones for use when a telephone call is received by the mobile telephone.

The use of personalised ring tones enables a user to customise his or her mobile telephone. The personalisation of a mobile telephone reduces the chances of two or more mobile telephones, in the same vicinity, having the same ring tone, decreasing the likelihood of confusion.

The personalisation of ring tones is described in U.S. Pat. No. 6,094,587 (Armanto et al.) and U.S. Pat. No. 6,366,791 (Lin et al.).

U.S. Pat. No. 6,094,587 (Armanto et al.) discloses a method for transmitting a ring tone, attached to a SMS message, to a users mobile telephone. A received SMS message is identified as a ring tone by an identification code which indicates that a ring tone is attached to the SMS message. The identification code can be stored in the data field of the SMS message, in which the actual message is stored, or in the address field of the SMS message, in which the address of the message destination is stored. When a SMS message is received, a data processing unit (DU) determines if the SMS message is a text message or a ring tone message. If the SMS message is a text message, then the DU reports that a text message has been received. If the SMS message contains an identification code, indicating that a ring tone is attached to the SMS message, then the DU transforms the SMS message into a ring tone and stores the ring tone in a permanent memory. The SMS ring tone message can be sent from one mobile telephone to another, or from a personal computer (PC) which is connected to the internet.

U.S. Pat. No. 6,366,791 (Lin et al.) discloses a method for allowing network operators to download ring tones, selected by a user, to a mobile telephone. A music score which is to be downloaded as a ring tone is associated with a ringing tone pattern. A user can select a music score and download the associated ringing tone pattern to a mobile telephone. The selected ringing tone pattern can be sent from a web page which displays the various music scores, via the internet to a mobile telephone, via a SMS message. When received, the mobile telephone is programmed by the subscriber identity module (SIM) card to use the received ringing tone pattern when calls are received. If a mobile telephone has two telephone numbers (N1, N2), a user may download one ringing tone pattern for use when a call is received by N1 and may download another ringing tone pattern for use when a call is received by N2.

It is also possible for a user to personalise his or her mobile telephone by downloading different back drops for the mobile telephone.

Text-to-Speech (TTS) systems are currently being developed and will shortly be incorporated into communication enabled devices such as mobile telephones. TTS systems convert a message comprising text into an audio message. In communication enabled devices such as mobile telephones, computers, and personal digital assistants (PDAs), TTS systems are capable of converting a received text message such as a short message service (SMS), an e-mail and/or a web page into an audio message to be played through the communication enabled device's speaker. The message may also be displayed on the communication enabled device's display screen.

TTS systems produce an output audio signal which has a “voice” having characteristics defined by a voice parameter set. Typically the voice parameter set comprises a non-distinctive “voice”, but equally the voice parameter set could define the “voice” as being similar to that of a famous person or a cartoon character. In addition, the “voice” may have a specific characteristic such as “scary”, “sexy” or “cute”, etc.

It is an aim of the present invention to enable a user to personalise his or her communication enabled device which comprises a TTS system. The user is able to personalise the communication enabled device by setting an active voice parameter set as the “voice” of the communication enabled device when text messages are received. The user may choose a voice parameter set from a selection of voice parameter sets stored prior to retail of the communication enabled device, or may obtain voice parameter sets from a provider, for use as the active voice parameter set.

Thus, in order to personalise communication enabled devices, the present invention provides a semiconductor chip comprising: a Text-To-Speech (TTS) system for converting an input text signal into an output audio signal, said output audio signal having characteristics defined by an active voice parameter set; and applying means, coupled to said TTS system, for providing said active voice parameter set to said TTS system.

Accordingly, the semiconductor chip of the present invention enables a user to personalise his or her communication enabled device. Each user can select the “voice” of their communication enabled device, thus the chances of two or more communication enabled devices, in the same vicinity, having the same “voice” is virtually avoided.

Embodiments of the present invention will now be described by way of further example only and with reference to the accompanying drawings, in which:

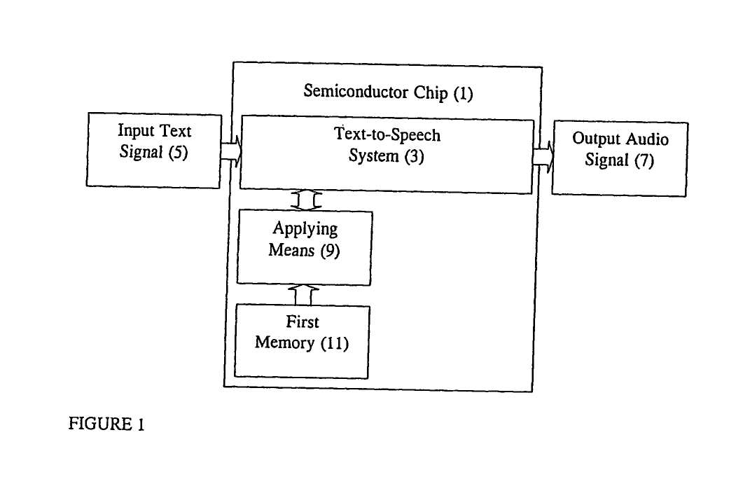

FIG. 1 illustrates a semiconductor chip of the first embodiment of the present invention;

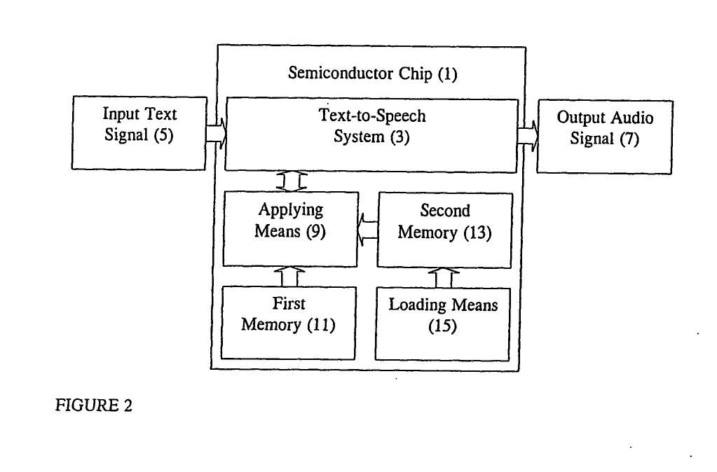

FIG. 2 illustrates a semiconductor chip of the second embodiment of the present invention;

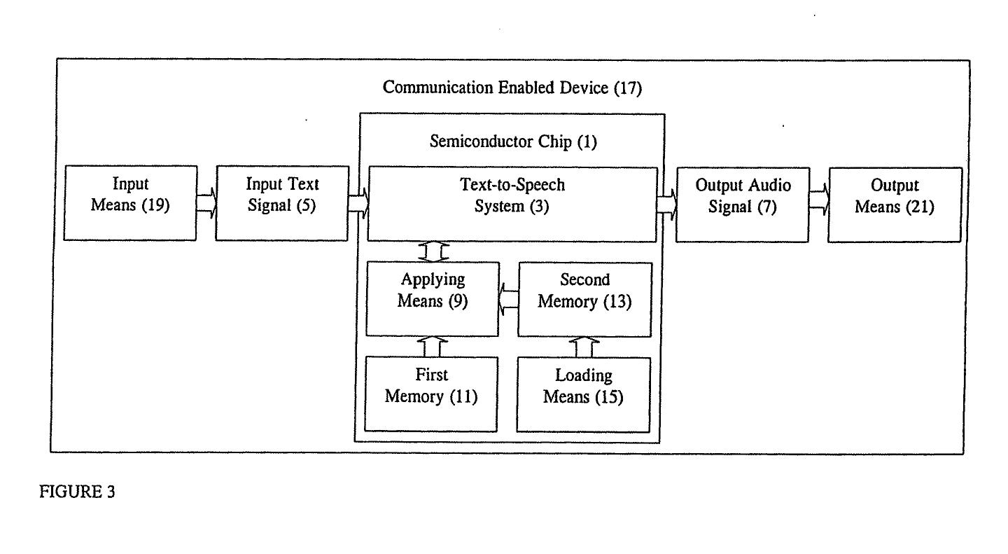

FIG. 3 illustrates a communication enabled device comprising a semiconductor chip of the second embodiment of the present invention;

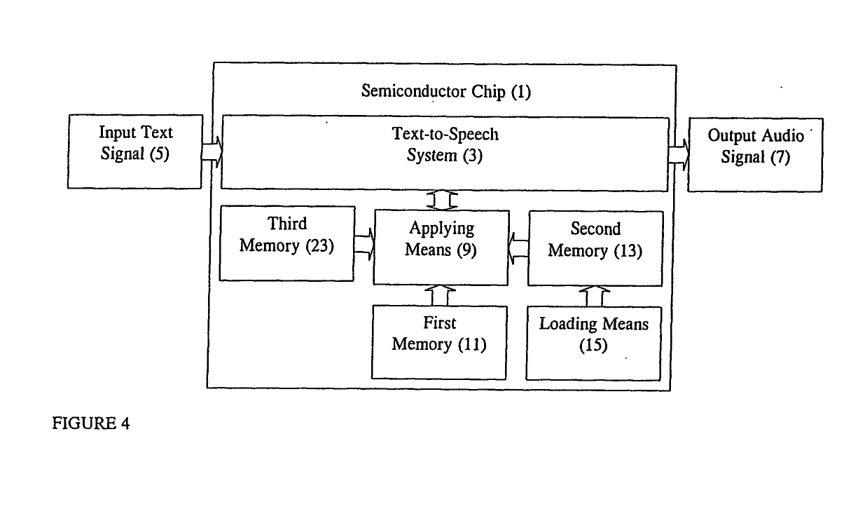

FIG. 4 illustrates a semiconductor chip of the third embodiment of the present invention;

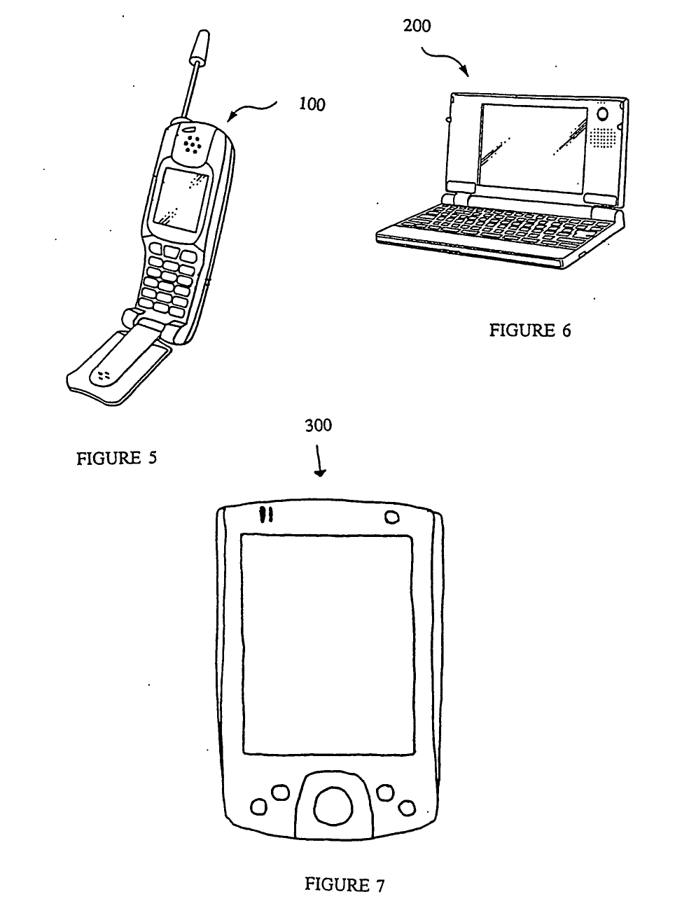

FIG. 5 illustrates a mobile telephone comprising a semiconductor chip of the present invention;

FIG. 6 illustrates a lap-top computer comprising a semiconductor chip of the present invention; and

FIG. 7 illustrates a personal digital assistant comprising a semiconductor chip of the present invention.

FIG. 1 illustrates a semiconductor chip 1 of the first embodiment of the present invention. The semiconductor chip 1 comprises a Text-to-Speech (TTS) system 3. The TTS system 3 converts an input text signal 5 into an output audio signal 7 by methods known in the art, such as disclosed in “Speech Technology for Telecommunications”, by F. A. Westall, R. D. Johnston and A. V. Lewis, Chapman and Hall, 1988, pages 127 to 207.

The output audio signal 7 has a “voice” having characteristics defined by an active voice parameter set. The active voice parameter set is applied to the TTS system 3 by an applying means 9, which is coupled to the TTS system 3.

The semiconductor chip 1 also comprises a first memory 11, coupled to the applying means 9. The first memory 11 stores at least one first voice parameter set which is provided to the TTS system 3 by the applying means 9. The first voice parameter set(s) may be stored in the first memory 11 at any time prior to retail of a communication enabled device in which the semiconductor chip 1 is incorporated. For example, the first voice parameter set(s) can be stored either during manufacture of the semiconductor chip 1 or following assembly of the semiconductor chip 1 within a communication enabled device. The first memory 11 may store as many first voice parameter sets as desired and is only limited by the capacity of the first memory 11.

Any one of the first voice parameter sets stored in the first memory 11 may be set as the active voice parameter set for use by the TTS system 3 when an input text message is received. The active voice parameter set may be selected at any time prior to the retail of a communication enabled device to a user, or may be set by a user. The active voice parameter set defines the characteristics of the “voice” to be used by the TTS system 1 when converting an input text signal 5 into an output audio signal 7. The output audio signal 7 may be relayed through a loud speaker of the communication enabled device or through an earpiece attached to the communication enabled device in which the semiconductor chip 1 is incorporated.

The selection of a first voice parameter set as the active voice parameter set by a user is achieved via an input means of a communication enabled device in which the semiconductor chip 1 is incorporated. The input means of the communication enabled device interfaces with the applying means 9 of the semiconductor chip 1. A user can play a sample of each first voice parameter set and can select any one of the first voice parameter sets to be the active voice parameter set. The user's selection of a first voice parameter set as the active voice parameter set overrides any previously set active voice parameter set. Consequently, a user can change the active voice parameter set as many times as desired.

FIG. 2 illustrates a semiconductor chip 1 of the second embodiment of the present invention, wherein like components have like reference numerals. The semiconductor chip 1 of the second embodiment of the present invention is similar to the semiconductor chip 1 of the first embodiment of the present invention. However, the semiconductor chip 1 of the second embodiment further comprises a second memory 13, coupled to the applying means 9, and a loading means 15 coupled to the second memory 13.

The first memory 11 and the second memory 13 may form one memory.

The second memory 13 stores second voice parameter sets. The second memory 13 can store any number of second voice parameter sets and is only limited by the capacity of the second memory 13. The second voice parameter sets are input into the loading means 15, which stores them in the second memory 13. The loading means 15 may also format each second voice parameter set, prior to storing them in the second memory 13, if required. In a preferred embodiment, the second voice parameter sets define voice parameter set which are different from the first voice parameter sets stored in the first memory 11. However, if desired, second voice parameter sets may be stored in the second memory 13 which are identical to the first voice parameter sets stored in the first memory 11.

A user can obtain second voice parameter sets from an external provider. For example, a user can download a second voice parameter set from a web page over the internet, using wireline communication. This may be possible if a communication enabled device in which the semiconductor chip 1 of the second embodiment of the present invention is incorporated is, for example, a laptop computer which is connected to a telephone line. Alternatively, a user can download a second voice parameter set from a web page over the internet, using wireline or wireless communication, the second voice parameter set may then be sent to the communication enabled device in which the semiconductor chip 1 is incorporated, attached to a SMS message, using wireless communication. It is also possible to obtain second voice parameter sets from an external provider where the user sends a SMS text message to the provider requesting a second voice parameter set and the provider then sends a SMS message, with the second voice parameter set attached, to the user's communication enabled device. The above examples are illustrations only and are not limiting. A user may also receive second voice parameter sets from other sources, such as from a user of a communication enabled device which contains second voice parameter sets.

When a second voice parameter set is received by the loading device 15 of the semiconductor chip 1, it is saved in the second memory 13 and is set as the active voice parameter set, overriding any previously set active voice parameter set.

Furthermore, a user can select any one of the first or second voice parameter sets, stored in the first or second memories 11, 13, as the active Voice parameter set for use by the TTS system 3. This enables a user to personalise a communication enabled device in which the semiconductor chip 1 is incorporated, as the user can choose from a wide range of voice parameter sets and is not limited to the first voice parameter sets provided in the first memory 11.

As stated above, the second memory 13 is limited in the number of second voice parameter sets which it can store by the capacity of the second memory 13. Thus, it is possible for a user to delete any one of, or all of, the second voice parameter sets from the second memory 13. This enables a user to delete voice parameter sets which are no longer desired freeing space in the second memory 13 for the input of new second voice parameter sets.

It is also possible for a user to delete any one of, or all but one of, the first voice parameter sets from the first memory 11. However, there must be at least one first voice parameter set, for use as the active voice parameter set, stored in the first memory 11 at all times.

FIG. 3 illustrates, in schematic form, a communication enabled device 17 comprising a semiconductor chip 1 of the second embodiment of the present invention. The communication enabled device 17 comprises an input means 19 and an output means 21. The output means 21 may be, but is not limited to, a loudspeaker or an earpiece which enables a user to listen to the output audio signal 7 produced by the TTS system 3. The input means 19 may be, but is not limited to, a key pad.

The active voice parameter set selected by the user or set prior to retail may be the active voice parameter set for all text messages received by the communication enabled device in which a semiconductor chip 1 of the present invention is incorporated.

Alternatively, different first or second voice parameter sets can be selected as the active voice parameter set for different types of text messages, such as SMS messages, e-mails or web pages. For example, when a SMS message is received, it is converted into an output audio signal 7, by the TTS system 3, having a “voice” of the SMS message active voice parameter set. However, when an email is received, it is converted into an output audio signal 7, by the TTS system 3, having a “voice” of the email active voice parameter set, different from the SMS message active voice parameter set.

Additionally, if a semiconductor chip 1 or the communication enabled device in which it is incorporated comprises an address book, then a user can select different first or second voice parameter sets as the active voice parameter set for all or some of the entries in the address book. For example, when a text message is received from a communication enabled device who's identification number (e.g. telephone number) is entered in the address book, and the identification number has a first or second voice parameter set selected as the active voice parameter set, the message is converted into an output audio signal 7, by the TTS system 3, having a “voice” of the selected active voice parameter set.

FIG. 4 illustrates a semiconductor chip 1 comprising a third memory 23 which stores an address book.

The selection of the active voice parameter set can be done prior to a message being received. Alternatively, if a message is saved following receipt, then a user changes the active voice parameter set to a different active voice parameter set prior to replaying the saved message, then the saved message is converted into an output audio signal 7, by the TTS system 3, having a “voice” of the different active voice parameter set. Consequently, a user can listen to the same text message in as many different voice parameter sets as desired.

In addition, it is possible for a communication enabled device in which a semiconductor chip 1 is incorporated to receive text messages which have a first or second voice parameter set selected as the active voice parameter set, prior to being sent by a sender. The TTS system 3 converts the received text message into an output audio signal 7 having a “voice” of the active voice parameter set selected prior to sending the text message. The active voice parameter set selected prior to sending the text message overrides the active voice parameter set selected in the recipient communication enabled device.

Accordingly, it is also possible for a communication enabled device in which a semiconductor chip 1 is incorporated to send text messages which have a first or second voice parameter set selected as the active voice parameter set, prior to being sent. In these circumstances, the user must be aware of the first and second voice parameter sets stored in the first and second memories 11, 13 of the recipient communication enabled device, prior to sending the text message.

Additionally, it is possible for a communication enabled device in which a semiconductor chip 1 is incorporated to receive text messages which have a first or second voice parameter set attached to the message as the active voice parameter set. The TTS system 3 converts the received text message into an output audio signal 7 having a “voice” of the attached active voice parameter set. The attached active voice parameter set overrides the active voice parameter set selected in the recipient communication enabled device.

Accordingly, it is also possible for a communication enabled device in which a semiconductor chip 1 is incorporated to send text messages having a first or second voice parameter set attached to the message, by a user as the active voice parameter set.

A voice parameter set may be sent from a communication enabled device in a modified or unmodified state.

The first memory 11, second memory 13 and third memory 23 may all be non-volatile memory.

Finally, it is also possible for a communication enabled device in which a semiconductor chip 1 is incorporated to display an input text message on a display device, such as a liquid crystal display, as an output text message. The output text message can be displayed simultaneously with the output audio signal 7.

A communication enabled device incorporating a semiconductor chip 1 of the present invention, may be an electronic device or a non-electronic device such as an organic of nano-mechanical processor.

Although the description and claims refer to a semiconductor chip 1, it is envisaged that the present invention may be realised using another processor based on non-semiconductor technology.

The communication enabled device may be a portable communication enabled device such as a mobile telephone 100, incorporating a semiconductor chip 1 of the first, second or third embodiment of the present invention, as illustrated in FIG. 5, a laptop computer 200, incorporating a semiconductor chip 1 of the first, second or third embodiment of the present invention, as illustrated in FIG. 6, or a personal digital assistant 300, incorporating a semiconductor chip 1 of the first, second or third embodiment of the present invention, as illustrated in FIG. 7.

The aforegoing description has been given by way of example only and it will be appreciated by a person skilled in the art that modifications can be made without departing from the scope of the present invention.

1. A semiconductor chip comprising:
a Text-To-Speech (TTS) system for converting an input text signal into an output audio signal, said output audio signal having characteristics defined by an active voice parameter set; and
applying means, coupled to said TTS system, for providing said active voice parameter set to said TTS system.

2. The semiconductor chip according to claim 1, further comprising a first memory, coupled to said applying means, said first memory storing a predetermined first voice parameter set.

3. The semiconductor chip according to claim 2, wherein said active voice parameter set comprises said first voice parameter set.

4. The semiconductor chip according to claim 2, wherein said first memory stores a plurality of predetermined first voice parameter sets.

5. The semiconductor chip according to claim 4, wherein said active voice parameter set comprises one of said plurality of first voice parameter sets.

6. The semiconductor chip according to claim 5, wherein a user selects one of said plurality of first voice parameter sets as said active voice parameter set.

7. The semiconductor chip according to claim 1, further comprising:
a second memory, coupled to said applying means; and
loading means coupled to said second memory.

8. The semiconductor chip according to claim 7, wherein a second voice parameter set is input into said loading means, and wherein said loading means stores said second voice parameter set in said second memory.

9. The semiconductor chip according to claim 8, wherein said loading means formats said second voice parameter set prior to storing said second voice parameter set in said second memory.

10. The semiconductor chip according to claim 8, wherein said active voice parameter set comprises said second voice parameter set.

11. The semiconductor chip according to claim 8, wherein said second memory stores a plurality of said second voice parameter sets.

12. The semiconductor chip according to claim 11, wherein said active voice parameter set comprises a last received second voice parameter set.

13. The semiconductor chip according to claim 8, wherein said active voice parameter set comprises one of said first or second voice parameter sets.

14. The semiconductor chip according to claim 13, wherein a user selects one of said first or second voice parameter sets as said active voice parameter set.

15. The semiconductor chip according to claim 8, wherein a type of input text signal is associated with one of said first or second voice parameter sets, and wherein said active voice parameter set comprises said associated voice parameter set when said type of input text signal is received by said TTS system.

16. The semiconductor chip according to claim 15, wherein a user associates said type of input text signal with one of said first or second voice parameter sets.

17. The semiconductor chip according to claim 15, wherein said type of input text signal is a Short Message Service (SMS) input text signal.

18. The semiconductor chip according to claim 15, wherein said type of input text signal is an email input text signal.

19. The semiconductor chip according to claim 15, wherein said type of input text signal is a web page input text signal.

20. The semiconductor chip according to claim 8, further comprising:
a third memory, coupled to said applying means, said third memory storing at least one identification feature, wherein one of said first or second voice parameter sets is assigned to said identification feature, and wherein said active voice parameter set comprises said assigned voice parameter set when said input text signal comprises said identification feature.

21. The semiconductor chip according to claim 20, wherein a user assigns one of said first or second voice parameter set to said identification feature.

22. The semiconductor chip according to claim 20, wherein said identification feature is an address of said input text signal.

23. The semiconductor chip according to claim 1, wherein one of said first or second voice parameter sets is linked to said input text signal, prior to said input text signal being received by said TTS system, and wherein said active voice parameter set comprises said linked voice parameter set.

24. The semiconductor chip according to claim 1, wherein one of said first or second voice parameter sets is attached to said input text signal, prior to said input text signal been received by said TTS system, and wherein said active voice parameter set comprises said attached voice parameter set.

25. The semiconductor chip according to claim 1, wherein one of said first or second voice parameter sets is linked to an output text signal, and wherein said active voice parameter set comprises said linked voice parameter set.

26. The semiconductor chip according to claim 25, wherein a user links one of said first or second voice parameter set to said output text signal.

27. The semiconductor chip according to claim 1, wherein one of said first or second voice parameter sets is attached to an output text signal, and wherein said active voice parameter set comprises said attached voice parameter set.

28. The semiconductor chip according to claim 27, wherein a user attaches one of said first or second voice parameter set to said output text signal.

29. The semiconductor chip according to claim 1, wherein said first, second and third memories are non-volatile memories.

30. The semiconductor chip according to claim 1, wherein said first and second memory are one memory.

31. The semiconductor chip according to claim 1, wherein said second voice parameter set can be deleted from said second memory.

32. A communication enabled device comprising:
a semiconductor chip according to claim 1.
an input means coupled to said input of said TTS system;
an output audio means coupled to the output of said TTS system.

33. The communication enabled device according to claim 32, further comprising an output text means coupled to said semiconductor chip, and wherein said input text signal is converted into said output audio signal and an output text signal.

34. The communication enabled device according to claim 32, wherein said communication enabled device is a portable communication enabled device.

35. The communication enabled device according to claim 34, wherein said portable communication enabled device is a mobile telephone.

36. The communication enabled device according to claim 34, wherein said portable communication enabled device is a laptop computer.

37. The communication enabled device according to claim 34, wherein said portable communication enabled device is a personal digital assistant.

38. (canceled)

39. (canceled)
